(19) United States
(12) Patent Application Publication
(10) Pub. No.: US 2025/0306313 A1
(43) Pub. Date: Oct. 2, 2025

(54) HEAT SPREADERS FOR OPTICAL FIBER ARRAY INTERCONNECTS

(71) Applicant: Intel Corporation, Santa Clara, CA (US)

(72) Inventors: Kumar Abhishek SINGH, Phoenix, AZ (US); Feifei CHENG, Chandler, AZ (US); Ziyin LIN, Chandler, AZ (US); Saikumar JAYARAMAN, Chandler, AZ (US); Peter A. WILLIAMS, Phoenix, AZ (US); Darren A. VANCE, Gilbert, AZ (US); Todd R. COONS, Gilbert, AZ (US); Abir DEB, Chandler, AZ (US)

(21) Appl. No.: 18/622,186

(22) Filed: Mar. 29, 2024

(51) Int. Cl. G02B 6/42

(52) U.S. Cl. CPC G02B 6/4269; G02B 6/4239; G02B 6/4243; G02B 6/428

(57) ABSTRACT

Assemblies comprising semiconductor devices, heat spreaders, and fiber-based input output (IO) connections are provided. Methods of manufacturing assemblies comprising semiconductor devices, heat spreaders, and fiber-based input output (IO) connections are also provided.

### GOVERNMENT INTEREST STATEMENT

This Invention was made with Government support under Agreement No. N00164-19-9-0001, awarded by NSWC Crane Division. The Government has certain rights in the Invention.

### FIELD

Descriptions are generally related to optical input-output (10) systems for computing, and more particularly to assemblies including heat spreaders for optical interconnects that connect electronic circuits to optical circuits.

### BACKGROUND

Semiconductor chips are central to intelligent devices and systems, such as personal computers, laptops, tablets, phones, servers, and other consumer and industrial products and systems. Manufacturing semiconductor chips presents a number of challenges and these challenges are amplified as devices become smaller and performance demands increase. Challenges include, for example, unwanted material interactions, precision and scaling requirements, limited failure tolerance, and material and manufacturing costs.

Semiconductor chips contain integrated circuits that can use electricity or photons to process and distribute information. A photonic integrated circuit device (PIC) or optical chiplet is a chip that contains components such as waveguides, photodetectors, lasers, trans-impedance amplifiers, and/or polarizers that are used to distribute and convert photon- and/or electrical-based information. Lasers and photodetectors can convert electrical signals to optical signals, and vice versa. A PIC can convert light into an electrical signal and vice versa. Fiber-based optical connectors, such as fiber array units (FAUs) can transmit optical signals over longer distances similar to the way wires can be used to transmit electrical signals over longer distances, between, for example, computing devices. FAUs can connect a PIC directly as an optical IO interface. Connecting a multi-fiber push on connector (MPO) to a FAU with an optical cable allows the transmission of optical signals over distances.

### BRIEF DESCRIPTION OF THE DRAWINGS

The figures are provided to aid in understanding. The figures can include diagrams and illustrations of examples of structures, assemblies, data, methods, and systems. For ease of explanation and understanding, these structures, assemblies, data, methods, and systems, the figures are not an exhaustively detailed description. The figures therefore should not be understood to depict the entire metes and bounds of structures, assemblies, data, methods, and systems possible. Additionally, features are not necessarily illustrated relatively to scale due in part to the small sizes of some features and the desire for clarity of explanation in the figures.

FIGS. 1A-1B illustrate assemblies that include semiconductor devices and fiber-based input output (IO) connections that include assembly control features.

FIGS. 2A-2B provide heat spreaders that are useful in semiconductor device assemblies and that provide assembly control features.

FIGS. 3A-3B show additional heat spreaders that are useful in semiconductor device assemblies and that provide alternate examples of assembly control features.

FIG. 4 illustrates an optical assembly that includes a heat spreader that includes assembly control features.

FIG. 5 provides a method for manufacturing an assembly comprising semiconductor devices and fiber-based IO connections.

FIG. 6 provides an example of a computing system.

Descriptions of certain details and implementations follow, including non-limiting descriptions of the figures, which depict some examples and implementations.

### DETAILED DESCRIPTION

References to one or more examples are to be understood as describing a particular feature, structure, or characteristic included in at least one implementation. The phrases “one example” or “an example” are not necessarily all referring to the same example or embodiment. Any aspect described herein can potentially be combined with any other aspect or similar aspect described herein, regardless of whether the aspects are described with respect to the same figure or element.

The words “connected” and/or “coupled” can indicate that two or more elements are in direct physical or electrical contact with each other. The term “coupled,” however, can also mean that two or more elements are not in direct contact with each other and are instead separated by one or more elements but they may still co-operate or interact with each other, for example, physically, magnetically, optically, or electrically.

The words “first,” “second,” and the like, do not indicate order, quantity, or importance, but rather are used to distinguish one element from another. The words “a” and “an” herein do not indicate a limitation of quantity, but rather denote the presence of at least one of the referenced items. The terms “follow” or “after” can indicate immediately following or following some other event or events. Other sequences of operations can also be performed according to alternative embodiments. Furthermore, additional operations may be added or removed depending on the application.

Disjunctive language such as the phrase “at least one of X, Y, or Z,” is used in general to indicate that an element or feature, may be either X, Y, or Z, or any combination thereof (e.g., X, Y, and/or Z). Thus, this disjunctive language should be understood not to imply that certain embodiments require at least one of X, at least one of Y, or at least one of Z to each be present.

Flow diagrams as illustrated herein provide examples of sequences of various process actions. The flow diagrams can indicate operations to be executed by a software or firmware routine, as well as physical operations. Physical operations can be performed by semiconductor processing equipment. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted and not all implementations will perform all actions.

Various components described can be a means for performing the operations or functions described. Each component described can include software, hardware, or a combination of these. Some components can be implemented as software modules, hardware modules, special-purpose hardware (for example, application specific hardware, application specific integrated circuits (ASICs), digital signal processors (DSPs), etc.), embedded controllers, or hardwired circuitry).

To the extent various computer operations or functions are described herein, they can be described or defined as software code, instructions, configuration, and/or data. The software content can be provided via an article of manufacture with the content stored thereon, or via a method of operating a communication interface to send data via the communication interface. A machine-readable storage medium can cause a machine to perform the functions or operations described. A machine-readable storage medium includes any mechanism that stores information in a tangible form accessible by a machine (e.g., computing device), such as recordable/non-recordable media (e.g., read only memory (ROM), random access memory (RAM), magnetic disk storage media, optical storage media, flash memory devices). Instructions can be stored on the machine-readable storage medium in a non-transitory form. A communication interface includes any mechanism that interfaces to, for example, a hardwired, wireless, or optical medium to communicate to another device, such as, for example, a memory bus interface, a processor bus interface, an Internet connection, a disk controller.

Terms such as chip, die, IC (integrated circuit) chip, IC die, microelectronic chip, microelectronic die, photonic integrated circuit device (PIC), semiconductor die, semiconductor device, and/or semiconductor chip are interchangeable and refer to a semiconductor device comprising integrated circuits.

Semiconductor chip manufacturing processes are sometimes divided into front end of the line (FEOL) processes and back end of the line (BEOL) processes. Electronic circuits and active and passive devices within the chip, such as for example, transistors, capacitors, resistors, and/or memory cells, are manufactured in what can be referred to as FEOL processes. Memory cells include, for example, electronic circuits for random access memory (RAM), such as static RAM (sRAM), dynamic RAM (DRAM), read only memory (ROM), non-volatile memory, and/or flash memory. FEOL processes can be, for example, complementary metal-oxide semiconductor (CMOS) processes. BEOL processes include metallization of the chip where interconnects are formed in layers and the feature size of the interconnect increases in layers nearer the surface of the semiconductor chip. Interconnects in, for example, semiconductor chips that are integrated into heterogeneous packages (such as, for example, packages that include memory and logic chips), can also include through silicon vias (TSVs) that transverse the semiconductor chip device region. Semiconductor devices that have TSVs can blur distinctions between BEOL and FEOL processes.

Semiconductor chip interconnects can be created by forming a trench or though-layer via by etching a trench or via structure into a dielectric layer and filling the trench or via with metal. Dielectric layers can comprise, for example, low-K dielectrics, SiO₂, silicon nitride (SiN), silicon carbide (SiC), and/or silicon carbonitride (SiCN). Low-K dielectrics include for example, fluorine-doped SiO₂, carbon-doped SiO₂, porous SiO₂, porous carbon-doped SiO₂, combinations for the foregoing, and also these materials with airgaps. Dielectric layers that include conducting features can be intermetal dielectric (ILD) features.

The terms “package,” “packaging,” “IC package,” or “chip package,” “microelectronics package,” or “semiconductor chip package” are interchangeable and generally refer to an enclosed carrier of one or more dies, in which the dies are attached to a package substrate and encapsulated. The package substrate provides electrical interconnects between the die(s) and other dies and/or, a second level interconnect circuit board, a motherboard or other circuit board for IO (input-output) communication and power delivery. A package with multiple dies can, for example, be a system in a package.

A package substrate generally includes dielectric layers or structures having conductive structures on, through, and/or embedded in the dielectric layers. The dielectric layers can be, for example, build-up layers. Dielectric materials include Ajinomoto build-up film (ABF), although other dielectric materials are possible. Semiconductor package substrates can have cores or be coreless. Semiconductor packages having cores can have dielectric layers such as buildup layers on more than one side of a core, such as on two opposite sides of a core. Cores can include through-core vias that contain a conductive material. Other structures or devices are also possible within a package substrate.

A “core” or “package core” generally refers to a layer usually embedded within a package substrate. The core can provide structure or stiffness to a package substrate. A core is an optional feature of a package substrate. The core can be a dielectric organic or inorganic material and may have conductive vias extending through the layer. The conductive vias can include a metal, for example, copper. A package core can, for example, be comprised of a glass material (such as, for example, aluminosilicate, borosilicate, alumino-borosilicate, silica, and fused silica), silicon, silicon nitride, silicon carbide, gallium nitride, or aluminum oxide. In some examples, core materials are glass-fiber reinforced organic resins such as epoxy-based resins. A further example package substrate core is FR4 (woven glass fiber reinforces epoxy). In other examples, package substrate cores are solid amorphous glass materials.

Attaching materials having differing properties in a robust manner can present challenges. For example, attaching a flexible fiber array unit (FAU) to a rigid carrier containing semiconductor devices can present difficulties since the FAU is bendable and is expected to flex and undergo stresses during user installation and end-use. The materials of the ridged carrier are different from that of the FAU and have different adhesion properties. For example, epoxy adhesion to a nickel-plated (or gold-plated) heat spreader can be very poor. Additionally, the assembly during manufacture and after installation may undergo temperature changes beyond the typical room temperature range.

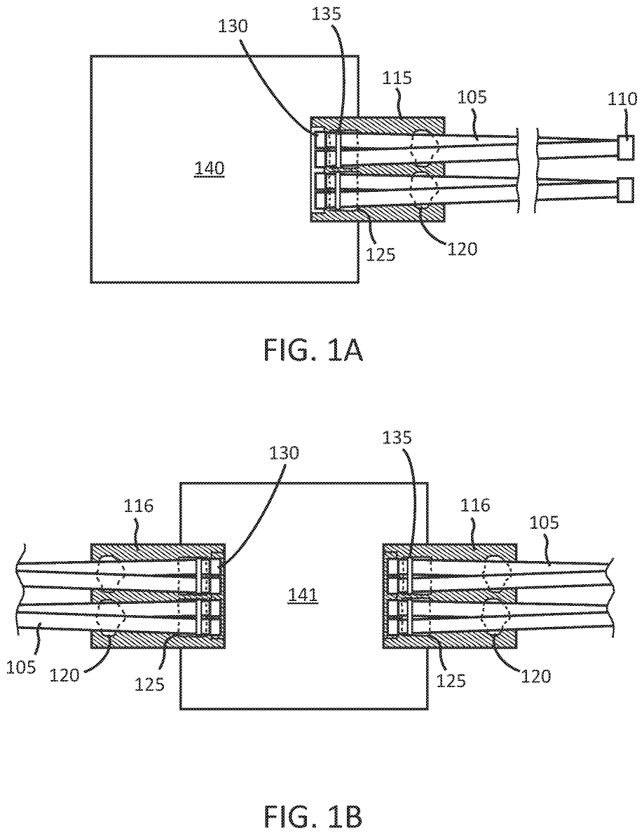

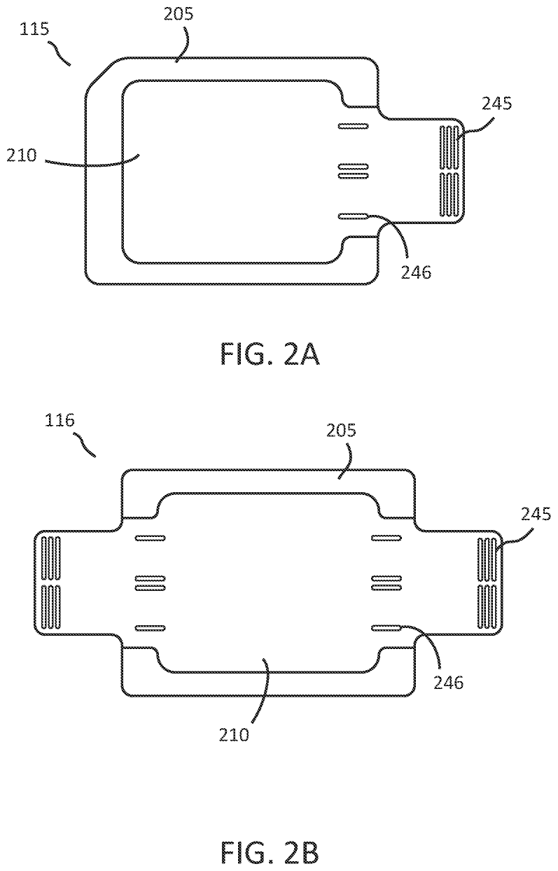

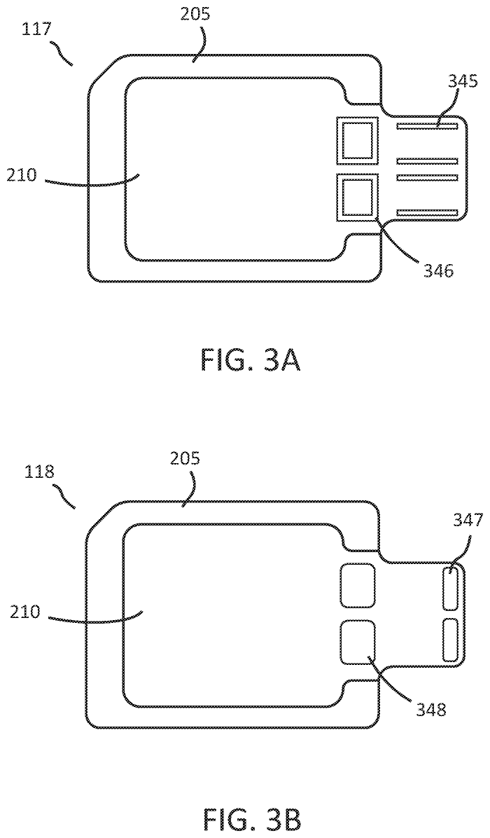

FIGS. 1A-1B provide illustrations of assemblies comprising semiconductor devices and fiber-based input output (IO) connections. The fiber-based IO connection can be, for example, a fiber-array unit (FAU), a fiber array, or a fiber-optic array. The fiber-based IO connection includes optical fibers 105 which can be single or multi-dimensional arrays of optical fibers. Although two optical fiber groups 105 and four optical fiber groups 105 are shown in FIG. 1A and FIG. 1B, respectively, other numbers of fiber groups 105 are possible, such as, one, three, four, or more. Optical fibers 105 can have a length that is appropriate for the system or application in which they are deployed and/or can be connected through, for example, a multi-fiber push on connector (MPO) to an optical cable. Optical fibers 105 can have a length that is less than 100 mm long. Optical fibers 105 can optionally include a glass block region 135. Optical fibers 105 can optionally terminate in optical fiber connectors 110 such as, for example a MPO connectors. Optical fibers 105 are attached to heat spreaders 115 and 116 through adhesive regions 120 and 125 that are between the optical fibers 105 and the heat spreaders 115 and 116. Optical fibers 105 are attached to the heat spreader 115 or 116 by adhesive region 120 and the optional glass block 135 is connected and the heat spreaders 115 or 116 by adhesive region 125. FIGS. 2A-2B and 3A-3B show examples of heat spreaders that are useful, for example, in the assemblies of FIGS. 1A-1B. In the perspective view provided by FIGS. 1A-1B, some of the adhesive regions 120 and 125 are beneath the optical fibers 105, and these regions are shown by a dashed line. The optical fibers 105 can terminate in an array of grooves 130 (such as v-shaped grooves), that aligns the optical fibers 105 with optical components, such as, for example, one or more optical chiplets or photonic integrated circuit (PIC) devices. Optical fibers 105 can contain any number of fibers, for example, the bundle of fibers can be 2 fibers or 100 optical fibers 105, and may be separated into any number of groupings of fibers. Optical fibers 105 in this example are shown bundled as ribbons, however they can also be in a cylindrical bundle in which the fibers fan out for connection to optical components through for example, an array of grooves 130. Other optical fiber 105 arrangements are also possible. Optical fibers 105 can provide any number of channels, for example, optical fibers 105 can provide 24 channels.

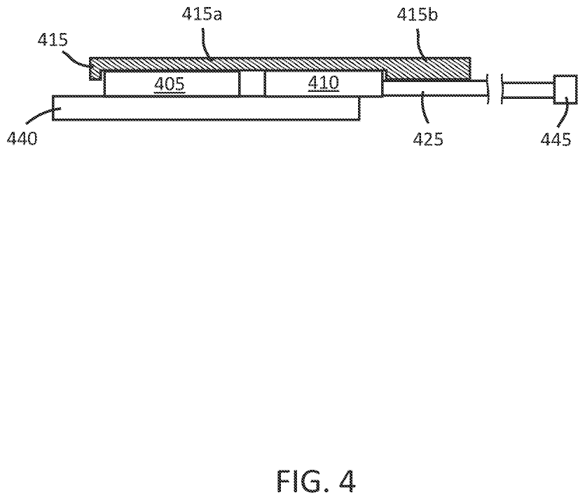

In the examples of FIGS. 1A-1B, packaged semiconductor devices are housed on circuit boards 140 or 141. Circuit boards 140 and 141 can be a printed circuit board or other housing for semiconductor devices that provides electrical interconnections and power delivery for the semiconductor devices. Circuit boards include, for example, motherboards, mainboards, and logic boards. The circuit boards 140 and 141 can also be connected to a second circuit board, such as a motherboard through, for example, a pin and socket or solder connection. FIG. 4 shows a rotated cut-through view of a device that is similar to that of FIG. 1A, for example, that illustrates semiconductor devices connected to a circuit board.

FIG. 1B provides a different configuration for fiber-based IO connections in which there are connections on two sides of the circuit board 141. Other configurations and locations for connections are also possible, such as, for example, fiber-based IO connections on three or four sides of the circuit boards 140 and 141 or fiber-based IO connections located at right angles to each other. Although not pictured in FIG. 1B, optical fibers 105 can optionally terminate in optical fiber connectors 110, which can be, for example, MPO connectors. Optical fibers can connect one or more devices over short or long distances for, for example, cluster computing. Cluster computing devices include super computers and server farms.

Adhesive regions 120 and 125 are regions that comprise an adhesive material. The adhesive material can be, for example, an epoxy material, an epoxy molding compound, an epoxy resin, an ultraviolet- (UV) curable material (such as an UV-curable epoxy), a thermosetting material (such as a heat-curable epoxy), a UV- and heat-curable material (such as a UV- and heat-curable epoxy) a self-curing epoxy. The adhesive regions 120 and 125 could also comprise a solder material, such as for example, a low or medium temperature solder. The adhesive material could be a rigid or flexible material.

FIGS. 2A-2B provide examples of heat spreaders that are useful, for example, in the assemblies and methods of FIGS. 1A-1B, 4A, and 5. In FIGS. 2A-2B, the heat spreaders 115 and 116 comprise a raised region 205 and a depression region 210. In an assembly, semiconductor devices generally reside in the depression region 210. Additionally, heat spreaders 115 and 116 include cavities 245 and 246 that are located in regions where adhesive (e.g., adhesive 120 and 125) is applied. Cavities 245 and 246 can provide additional surface area for adhesion of the adhesive and additionally can provide flow control during assembly processes. Adhesive material can flow into the cavities. Cavities 246 can be in the region where a glass block region 135 is adhered to a heat spreader 115 or 116. Although certain numbers of cavities 245 and 246 are illustrated, such as two rows of three trenches (for cavities 245), other numbers and placements and orientations of cavities are also possible. Additionally, although cavities 245 are illustrated, it is possible that these features are trenches having different shapes, such as cylindrical or non-linear trenches. Cavities 245 and 246 are located in regions of the heat spreaders 115 or 116 where adhesive material is applied to attach optical fibers to a semiconductor assembly.

FIGS. 3A-3B provide examples of heat spreaders that are useful, for example, in the assemblies and methods of FIGS. 1A-1B, 4A, and 5. In FIGS. 3A-3B, the heat spreaders 117 and 118 comprise a raised region 205 and a depression region 210. In an assembly, semiconductor devices generally reside in the depression region 210. Additionally, heat spreaders 117 and 118 include cavities 345, 346, 347, and 348 that are located in regions where adhesive (e.g., adhesive material 120 and 125) is applied. Cavities 345, 346, 347, and 348 can provide additional surface area for adhesion of the adhesive material and additionally can provide flow control during assembly processes. Cavities 346 and 348 can be in the region where an optional glass block region 135 is adhered to a heat spreader 117 or 118. Although certain numbers and shapes of cavities 345, 346, 347, and 348 are illustrated, such as four trenches (for cavities 345), two picture frame-shaped cavities 346, two rectangular trenches for cavities 347, and wider rectangular cavities 348, other numbers and placements and orientations of cavities are also possible. Cavities 345, 346, 347, and 348 are located in regions of the heat spreaders 117 or 118 where adhesive is applied to attach optical fibers to a semiconductor assembly.

Cavities 245, 246, 345, 346, 347, and 348 can have a depth of, for example, 0.1 to 2 mm or 0.1 to 1 mm. In some examples of heat spreaders, the cavities can have length dimensions of between 1 to 10 mm and with dimensions of between 0.1 to 2 mm.

Examples of heat spreaders described herein can include features that provide strain relief of the attached fibers, fiber support, and/or improved ease of mechanical attachment. Additionally, features can be useful for adhesive containment to prevent interference of the first adhesive impacting the alignment of second optical fibers. These features can be useful in assembling the devices shown in the examples in FIGS. 1A-1B.

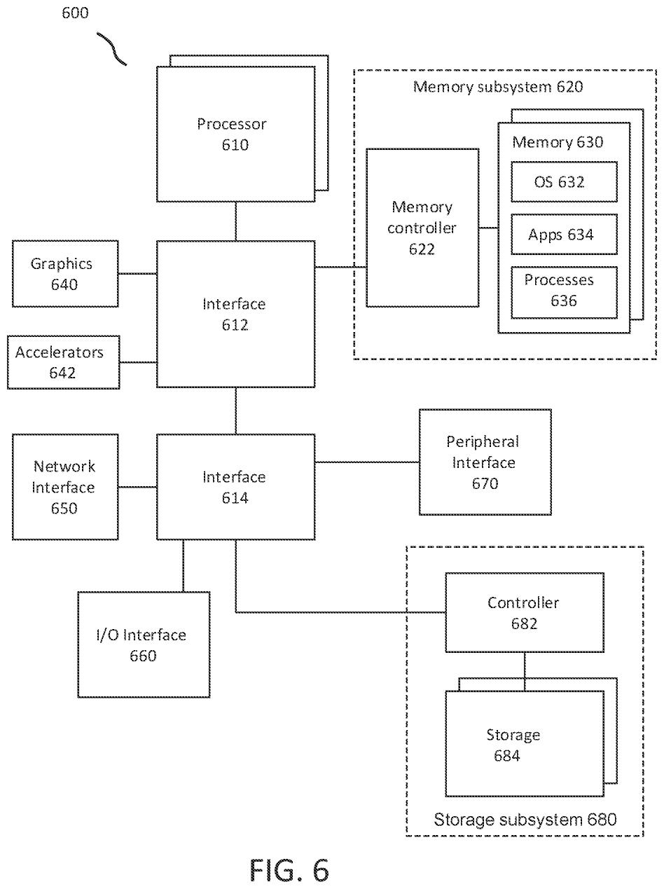

FIG. 4 provides a cut-through side view of part of an optical assembly, such as, for example, the assembly of FIG. 1A. In FIG. 4, the optical assembly includes semiconductor devices 405 and 410, heat spreader 415, optical fibers 425, optical fiber connectors 445, and circuit board 440. Although two semiconductor devices 405 and 410 are shown, other numbers of semiconductor devices are also possible in the assembly of FIG. 1A. Semiconductor devices 405 and 410 can be packaged semiconductor devices. Circuit board 440 can be a printed circuit board or other housing for semiconductor devices that provides electrical interconnections and power delivery for the semiconductor devices. Semiconductor devices 405 and 410 can be, for example, a processor such as, a central processing unit (CPU), a graphics processing unit (GPU), a field programmable gate array (FPGA), an infrastructure processing unit (IPU), a data processing unit (DPU), a GPGPU (general purpose computing on graphics processing units), a digital signal processor (DSP), a photonic integrated circuit, and/or other processing units (e.g., accelerator devices). Additionally, the semiconductor devices can be any of the semiconductor devices described with respect to FIG. 6. An IPU or DPU can include a network interface with one or more programmable pipelines or fixed function processors to perform offload of operations that can have been performed by a CPU. The IPU or DPU can include one or more memory devices. Memory devices can include, for example, synchronous dynamic random-access memory SDRAM chips and high bandwidth memory (HBM) die stacks. HBM can be stacked synchronous dynamic random-access memory SDRAM chips. Other semiconductor devices are also possible. In some examples, semiconductor device 405 can be a GPU, an IPU, a DPU, or a GPGPU (i.e., an xPU). In additional examples, the semiconductor device 410 can be a photonic integrated circuit device (PIC). A PIC can also be referred to as an integrated optical circuit device. A PIC generally includes two or more photonic components in addition to electrical integrated circuits. A PIC can generate, transport, convert, and/or process light-based signals. In additional examples, the semiconductor device 410 can be an xPU and the semiconductor device 410 can be a PIC. Circuit boards include, for example, motherboards, mainboards, and logic boards. The circuit board 440 can also be connected to a second circuit board, such as a motherboard through, for example, a pin and socket or solder connection (other types of connections are possible). Optical fiber connectors 445 can be MPO connectors.

Optical fibers 425 are attached to heat spreader 415. Optical fibers 425 can interface to semiconductor device 410 through, for example, a grooved array that aligns the optical fibers 425 with an optical component of semiconductor device 410. Optical fibers 425 can be single or multi-dimensional arrays of optical fibers. Optical fibers 425 can include a glass block region (not shown). The heat spreader 415 can be, for example, any of the heat spreaders shown and described herein with respect to FIGS. 1A-1B, 2A-2B, and 3A-3B. The heat spreader 415 includes cavities in adhesive attach regions for attaching the optical fibers 425 to the heat spreader 415. Other numbers and orientations of optical fiber attach regions are possible, such as, for example, the two regions shown in FIGS. 1B and 2B. The heat spreader 415 can make thermal contact with one or more of the semiconductor devices 405 and 410 through a thermal material, such as a thermal paste. The heat spreader 415 is coextensive with the circuit board 440 in a first region 415a and extends beyond the circuit board 440 in a second region 415b. Optical fibers 425 can be attached with adhesive material in the first coextensive region of the heat spreader 415a and also in the second region of the heat spreader 415b that extends beyond the circuit board.

The heat spreaders of FIGS. 1A-1B, 2A-2B, 3A-3B, and 4 (i.e., 115, 116, 117, 118, and 415) can be a continuous solid unit. The continuous solid unit can be made from a metal stamping, pressing process, or machining process. The heat spreader can be comprised of metal, such as, for example, copper, a copper alloy, copper plated with nickel, a copper alloy plated with nickel, aluminum, nickel, and/or a nickel alloy. The heat spreader can be a block of metal or a metal alloy. The heat spreader can be a block of metal or metal alloy plated with nickel, gold, an alloy of nickel and gold, or another metal. In alternate examples of heat spreader designs, the heat spreader can be comprised of more than one piece of material that are bonded together through epoxy or mechanical attachment (e.g., screws). If the heat spreader is assembled from more than one piece of material, different pieces can be comprised of the same or different materials.

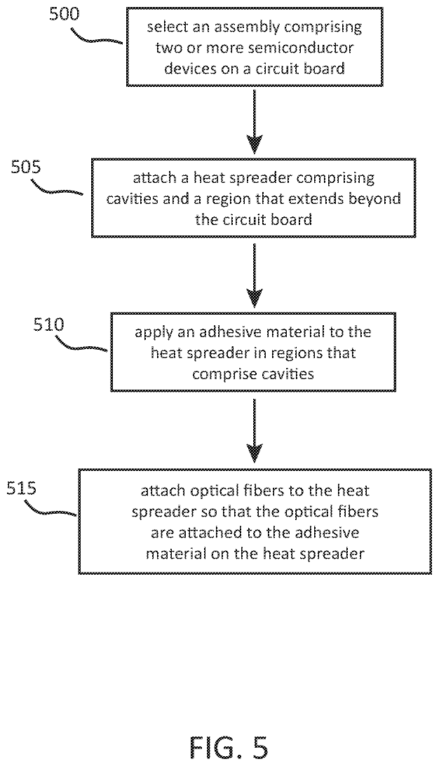

FIG. 5 provides a method for manufacturing an assembly that includes fiber-based IO connections. The assembly can any as described herein, for example, the assembly can be one of FIGS. 1A-1B and 4. A partially manufactured assembly comprising two or more semiconductor devices on a circuit board is selected 500. A heat spreader is attached to the partially manufactured assembly 505. The heat spreader has a first region that extends beyond the integrated circuit board and a second region that is coextensive with the circuit board. The heat spreader additionally comprises cavities. The heat spreader can be any of the heat spreaders described herein by FIGS. 2A-2B and 3A-3B. An adhesive material is applied to regions comprising cavities 510 or to the group/bundle of optical fibers. The cavity regions can contain the flow of the adhesive. A group (or bundle) of optical fibers is attached to regions of adhesive material on the heat spreader 515. The group of optical fibers can be attached to two regions of adhesive material on the heat spreader. The optical fibers can be inserted into grooves so that the optical fibers are aligned with an optical component of the assembly. The optical component can be, for example, a photonic integrated circuit device. The assembly can be accomplished using, for example, a 6-axis manipulator.

FIG. 6 depicts an example computing system which can include the fiber-based IO assemblies described herein. The fiber-based IO assemblies can, for example, provide communication pathways between server racks. A computing system 600 can include more, different, or fewer features than the ones described with respect to FIG. 6.

Computing system 600 includes processor 610, which provides processing, operation management, and execution of instructions for system 600. Processor 610 can include any type of microprocessor, CPU (central processing unit), GPU (graphics processing unit), processing core, or other processing hardware to provide processing for system 600, or a combination of processors or processing cores. Processor 610 controls the overall operation of system 600, and can be or include, one or more programmable general-purpose or special-purpose microprocessors, DSPs, programmable controllers, ASICs, programmable logic devices (PLDs), or the like, or a combination of such devices.

In one example, system 600 includes interface 612 coupled to processor 610, which can represent a higher speed interface or a high throughput interface for system components needing higher bandwidth connections, such as memory subsystem 620 or graphics interface components 640, and/or accelerators 642. Interface 612 represents an interface circuit, which can be a standalone component or integrated onto a processor die. Where present, graphics interface 640 interfaces to graphics components for providing a visual display to a user of system 600. In one example, the display can include a touchscreen display.

Accelerators 642 can be a fixed function or programmable offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard (or circuit board, printed circuit board, mainboard, system board, or logic board) that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 642 can provide multiple neural networks, CPUs, processor cores, general purpose graphics processing units, or graphics processing units can be made available for use by artificial intelligence (AI) or machine learning (ML) models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as static RAM (SRAM), dynamic RAM (DRAM), synchronous DRAM (SDRAM) and/or or other memory devices, or a combination of such devices. Memory 630 stores and hosts, among other things, operating system (OS) 632 that provides a software platform for execution of instructions in system 600, and stores and hosts applications 634 and processes 636. In one example, memory subsystem 620 includes memory controller 622, which is a memory controller to generate and issue commands to memory 630. The memory controller 622 can be a physical part of processor 610 or a physical part of interface 612. For example, memory controller 622 can be an integrated memory controller, integrated onto a circuit within processor 610.

System 600 can also optionally include one or more buses or bus systems between devices, such memory buses, graphics buses, and/or interface buses. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a peripheral component interface (PCI) or PCI express (PCIe) bus, a Hyper Transport or industry standard architecture (ISA) bus, a small computer system interface (SCSI) bus, a universal serial bus (USB), or a Firewire bus.

In one example, system 600 includes interface 614, which can be coupled to interface 612. In one example, interface 614 represents an interface circuit, which can include standalone components and integrated circuitry. In one example, user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB, or other wired or wireless standards-based or proprietary interfaces. Network interface 650 can transmit data to a device that is in the same data center or rack or a remote device, which can include sending data stored in memory.

Some examples of network interface 650 are part of an infrastructure processing unit (IPU) or data processing unit (DPU), or used by an IPU or DPU. An xPU can refer at least to an IPU, DPU, GPU, GPGPU (general purpose computing on graphics processing units), or other processing units (e.g., accelerator devices). An IPU or DPU can include a network interface with one or more programmable pipelines or fixed function processors to perform offload of operations that can have been performed by a CPU. The IPU or DPU can include one or more memory devices.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include additional types of hardware interfaces, such as, for example, interfaces to semiconductor fabrication equipment and/or electrostatic charge management devices.

In one example, system 600 includes storage subsystem 680. Storage subsystem 680 includes storage device(s) 684, which can be or include any conventional medium for storing data in a nonvolatile manner, such as one or more magnetic, solid state, and/or optical based disks. Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 612 or processor 610 or can include circuits or logic in both processor 610 and interface 614.

A power source (not depicted) provides power to the components of system 600. More specifically, power source typically interfaces to one or multiple power supplies in system 600 to provide power to the components of system 600.

Example systems may be implemented in various types of computing, smart phones, tablets, personal computers, and networking equipment, such as switches, routers, racks, and blade servers such as those employed in a data center and/or server farm environment.

### EXAMPLES

An assembly can comprise: two or more semiconductor devices on a circuit board; a heat spreader wherein a first region of the heat spreader extends beyond the circuit board wherein the heat spreader comprises a first and a second region comprising cavities and wherein there is a first region comprising cavities in the first region of the heat spreader that extends beyond the circuit board; adhesive material on the heat spreader in the first and the second regions comprising cavities wherein adhesive material is in the cavities; and a group of optical fibers wherein there is adhesive material between the group of optical fibers and the first region comprising cavities. The second region comprising cavities can be in a second region of the heat spreader that is coextensive with the circuit board. The cavities can have a depth between 0.1 to 1 mm. A semiconductor device of the two or more semiconductor devices can be a photonic integrated circuit device. The heat spreader can be a continuous solid unit. The adhesive material can be a heat-curable epoxy, ultraviolet light-curable epoxy, an ultraviolet light- and heat-curable epoxy, a self-curing epoxy, or a solder material. The cavities can be trenches, cylinders, or rectangular shapes.

An assembly can comprise: a first semiconductor device and a second semiconductor device on a circuit board wherein the first semiconductor device is a photonic integrated circuit device; a heat spreader wherein a region of the heat spreader is coextensive with the circuit board, wherein a region of the heat spreader extends beyond the circuit board, wherein there is a first cavity in the region of the heat spreader that extends beyond the circuit board, and wherein there is a second cavity in the region of the heat spreader that is coextensive with the circuit board; and a group of optical fibers wherein there is adhesive material between the group of optical fibers and the first cavity and there is adhesive material between the group of optical fibers and the second cavity. The second semiconductor device can be a processor, a graphics processing unit, an infrastructure processing unit, a data processing unit, or a general purpose computing on graphics processing unit. The heat spreader can be a multi-part unit. The cavities can be trenches, cylinders, or rectangular shapes. A cavity can have a picture frame shape. The heat spreader can be comprised of copper, a copper alloy, aluminum, nickel, or a nickel alloy. The adhesive material can be a heat-curable epoxy, ultraviolet light-curable epoxy, an ultraviolet light- and heat-curable epoxy, a self-curing epoxy, or a solder material.

A method for manufacturing an optical assembly can comprise: attaching a heat spreader to a circuit board wherein the circuit board comprises two or more semiconductor devices, wherein the heat spreader comprises a region that extends beyond the circuit board, wherein the heat spreader comprises a region that is coextensive with the circuit board, wherein the heat spreader comprises at least two regions that comprise a cavity, and wherein one region of the at least two regions that comprise a cavity is in the region that extends beyond the circuit board; applying an adhesive material in the at least two regions that comprise a cavity; and attaching optical fibers to the adhesive material in the at least two regions that comprise a cavity. The heat spreader can be comprised of copper, a copper alloy, aluminum, nickel, or a nickel alloy. The heat spreader can comprise a material comprising copper or nickel and that is plated with gold. A semiconductor device can be a photonic integrated circuit device. The adhesive material can be a heat-curable epoxy, ultraviolet light-curable epoxy, an ultraviolet light- and heat-curable epoxy, a self-curing epoxy, or a solder material. The method can also include aligning the optical fibers in grooves so that the optical fibers are coupled to an integrated circuit device.

Besides what is described herein, various modifications can be made to what is disclosed and implementations without departing from their scope. Therefore, the illustrations and examples herein should be construed in an illustrative, and not a restrictive sense.

What is claimed is:

1. An assembly comprising:
two or more semiconductor devices on a circuit board;
a heat spreader wherein a first region of the heat spreader extends beyond the circuit board wherein the heat spreader comprises a first and a second region comprising cavities and wherein there is a first region comprising cavities in the first region of the heat spreader that extends beyond the circuit board;
adhesive material on the heat spreader in the first and the second regions comprising cavities wherein adhesive material is in the cavities; and
a group of optical fibers wherein there is adhesive material between the group of optical fibers and the first region comprising cavities.

2. The assembly of claim 1, wherein the second region comprising cavities is in a second region of the heat spreader that is coextensive with the circuit board.

3. The assembly of claim 1 wherein the cavities have a depth between 0.1 to 1 mm.

4. The assembly of claim 1 wherein a semiconductor device of the two or more semiconductor devices is a photonic integrated circuit device.

5. The assembly of claim 1 wherein the heat spreader is a continuous solid unit.

6. The assembly of claim 1 wherein the adhesive material is a heat-curable epoxy, ultraviolet light-curable epoxy, an ultraviolet light- and heat-curable epoxy, a self-curing epoxy, or a solder material.

7. The assembly of claim 1 wherein the cavities are trenches, cylinders, or rectangular shapes.

8. An assembly comprising:
a first semiconductor device and a second semiconductor device on a circuit board wherein the first semiconductor device is a photonic integrated circuit device;
a heat spreader wherein a region of the heat spreader is coextensive with the circuit board, wherein a region of the heat spreader extends beyond the circuit board, wherein there is a first cavity in the region of the heat spreader that extends beyond the circuit board, and wherein there is a second cavity in the region of the heat spreader that is coextensive with the circuit board; and
a group of optical fibers wherein there is adhesive material between the group of optical fibers and the first cavity and there is adhesive material between the group of optical fibers and the second cavity.

9. The assembly of claim 8, wherein the second semiconductor device is a processor, a graphics processing unit, an infrastructure processing unit, a data processing unit, or a general purpose computing on graphics processing unit.

10. The assembly of claim 8, wherein the heat spreader is a multi-part unit.

11. The assembly of claim 8, wherein the cavities are trenches, cylinders, or rectangular shapes.

12. The assembly of claim 8 wherein a cavity has a picture frame shape.

13. The assembly of claim 8 wherein the heat spreader is comprised of copper, a copper alloy, aluminum, nickel, or a nickel alloy.

14. The assembly of claim 8 wherein the adhesive material is a heat-curable epoxy, ultraviolet light-curable epoxy, an ultraviolet light- and heat-curable epoxy, a self-curing epoxy, or a solder material.

15. A method for manufacturing an optical assembly comprising:
attaching a heat spreader to a circuit board wherein the circuit board comprises two or more semiconductor devices, wherein the heat spreader comprises a region that extends beyond the circuit board, wherein the heat spreader comprises a region that is coextensive with the circuit board, wherein the heat spreader comprises at least two regions that comprise a cavity, and wherein one region of the at least two regions that comprise a cavity is in the region that extends beyond the circuit board;
applying an adhesive material in the at least two regions that comprise a cavity; and
attaching optical fibers to the adhesive material in the at least two regions that comprise a cavity.

16. The method of claim 15, wherein the heat spreader is comprised of copper, a copper alloy, aluminum, nickel, or a nickel alloy.

17. The method of claim 15, wherein the heat spreader comprises a material that comprises copper or nickel and that is plated with gold.

18. The method of claim 15 wherein a semiconductor device is a photonic integrated circuit device.

19. The method of claim 15 wherein the adhesive material is a heat-curable epoxy, ultraviolet light-curable epoxy, an ultraviolet light- and heat-curable epoxy, a self-curing epoxy, or a solder material.

20. The method of claim 15 also including aligning the optical fibers in grooves so that the optical fibers are coupled to an integrated circuit device.
